(19) United States
(12) Patent Application Publication
(10) Pub. No.: US 2013/0143622 A1
(43) Pub. Date: Jun. 6, 2013

(54) LTE Communication Card and LTE Communication System

(71) Applicants: Shiqing Zhao, Huizhou City (CN); Xuelong Ronald Hu, Huizhou City (CN); Yang Ronald Ding, Huizhou City (CN)

(72) Inventors: Shiqing Zhao, Huizhou City (CN); Xuelong Ronald Hu, Huizhou City (CN); Yang Ronald Ding, Huizhou City (CN)

(73) Assignee: HUIZHOU TCL MOBILE COMMUNICATION CO., LTD., Huizhou City, Guangdong (CN)

(21) Appl. No.: 13/519,131

(22) PCT Filed: May 10, 2012
(86) PCT No.: PCT/CN12/75301

§ 371 Date: Jun. 25, 2012

(30) Foreign Application Priority Data
Dec. 2, 2011 (CN) 201110396406.2

(51) Int. Cl. H04B 1/40

(52) U.S. Cl. 455/558

(57) ABSTRACT

The present disclosure discloses an LTE communication card, which comprises: an SDIO interface, comprising data pins adapted to be selectively inserted into an SDIO card slot of an electronic device; an LTE baseband processing unit connected to the data pins, being configured to obtain from the data pins a first data signal supplied by the electronic device and modulate the first data signal; an LTE transceiving unit, being configured to obtain the first data signal that has been modulated; and an antenna unit, being configured to transmit the first data signal, and further obtain an LTE radio frequency (RF) signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the electronic device via the data pins. The present disclosure further discloses an LTE communication system. Through the above disclosure, the present disclosure can impart an LTE wireless communication function to an electronic device that supports the SDIO protocol so as to enrich functions of the electronic device, improve users' experiences and reduce the production cost.

### FIELD OF THE INVENTION

The present disclosure generally relates to the technical field of communication electronics, and more particularly, to a Long Term Evolution (LTE) communication card and an LTE communication system.

### BACKGROUND OF THE INVENTION

Nowadays, more and more electronic devices such as computer products or digital products are provided with SDIO (Secure Digital Input and Output) card slots. The SDIO card slots support use of SDIO cards provided with SDIO interfaces so that the electronic devices can use the SDIO cards to read or store relevant data. The SDIO card slots can also support SD cards.

Additionally, as a 3^{rd} generation (3G) wireless communication standard, the LTE communication standard has found wide application in the prior art. Electronic devices adopting the LTE communication standard can provide high-speed and stable network services for users.

However, generally speaking, conventional electronic devices that support the LTE communication standard must have an LTE communication module incorporated therein early in the manufacturing stage, and this leads to a high production cost. Moreover, the electronic devices provided with the SDIO card slots will be unable to provide the LTE communication function if no LTE communication module is built therein.

Accordingly, an LTE communication card which, when being inserted into an electronic device provided with an SDIO card slot, can impart an LTE communication function to the electronic device is expected. Such an LTE communication card will greatly enrich functions of electronic devices and improve users' experiences, and reduce the production cost of the electronic devices to some extent.

### SUMMARY OF THE INVENTION

An objective of the present disclosure is to provide an LTE communication card and an LTE communication system, which can impart an LTE wireless communication function to an electronic device that supports the SDIO protocol so as to enrich functions of the electronic device, improve users' experiences and reduce the production cost.

To achieve the aforesaid objective, the present disclosure provides an LTE communication card, which comprises: an SDIO interface, comprising data pins adapted to be selectively inserted into an SDIO card slot of an electronic device; an LTE baseband processing unit connected to the data pins, being configured to obtain from the data pins a first data signal supplied by the electronic device and modulate the first data signal; an LTE transceiving unit connected to the LTE baseband processing unit, being configured to obtain the first data signal that has been modulated; and an antenna unit connected to the LTE transceiving unit, being configured to transmit the first data signal, and further obtain an LTE radio frequency (RF) signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the electronic device via the data pins. The LTE communication card further comprises an LTE power management unit. The SDIO interface further comprises power pins adapted to be selectively inserted into the SDIO card slot of the electronic device. The LTE power management unit is configured to obtain from the power pins a power signal supplied by the electronic device and adjust the power signal correspondingly to power the LTE baseband processing unit and the LTE transceiving unit respectively.

To achieve the aforesaid objective, the present disclosure further provides an LTE communication system, which comprises an electronic device and an LTE communication card. The electronic device comprises: an SDIO card slot; and a data processing unit connected to the SDIO card slot, being configured to generate a first data signal to the SDIO card slot. The LTE communication card comprises: an SDIO interface, comprising data pins adapted to be selectively inserted into the SDIO card slot; an LTE baseband processing unit connected to the data pins, being configured to obtain the first data signal from the data pins and modulate the first data signal; an LTE transceiving unit connected to the LTE baseband processing unit, being configured to obtain the first data signal that has been modulated; and an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the SDIO card slot via the data pins. The data processing unit further obtains the second data signal from the SDIO card slot. The electronic device further comprises a power module configured to supply power to the data processing unit and output a power signal to the SDIO card slot. The LTE communication card further comprises an LTE power management unit. The SDIO interface further comprises power pins adapted to be selectively inserted into the SDIO card slot of the electronic device. The LTE power management unit is configured to obtain the power signal from the power pins and adjust the power signal correspondingly to power the LTE baseband processing unit and the LTE transceiving unit respectively.

To achieve the aforesaid objective, the present disclosure further provides an LTE communication card, which comprises: an SDIO interface, comprising data pins adapted to be selectively inserted into an SDIO card slot of an electronic device; an LTE baseband processing unit connected to the data pins, being configured to obtain from the data pins a first data signal supplied by the electronic device and modulate the first data signal; an LTE transceiving unit connected to the LTE baseband processing unit, being configured to obtain the first data signal that has been modulated; and an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the electronic device via the data pins.

Preferably, the LTE communication card further comprises a memory connected to the LTE baseband processing unit and configured to store a subscriber identification number (SIN), an authentication key, a location area identifier (LAI), a temporary subscriber identifier (TSI), a personal identification number (PIN), an unlock code, telephone book data, subscriber identification authentication data, an encryption algorithm and an encryption key.

Preferably, the LTE communication card further comprises an LTE power management unit, the SDIO interface further comprises power pins adapted to be selectively inserted into the SDIO card slot of the electronic device, and the LTE power management unit is configured to obtain from the power pins a power signal supplied by the electronic device and adjust the power signal correspondingly to power the LTE baseband processing unit, the LTE transceiving unit and the memory respectively.

Preferably, the SDIO interface, the LTE baseband processing unit, the LTE transceiving unit, the memory and the LTE power management unit are packaged in a card having dimensions of 32 mm×24 mm×2.1 mm.

Preferably, the antenna unit comprises an LTE main antenna and an LTE Multiple-Input Multiple-Output (MIMO) antenna.

Preferably, the antenna unit is disposed in an edge region of an enclosure of the card that is opposite to the SDIO interface.

To achieve the aforesaid objective, the present disclosure further provides an LTE communication system, which comprises an electronic device and an LTE communication card. The electronic device comprises: an SDIO card slot; and a data processing unit connected to the SDIO card slot, being configured to generate a first data signal to the SDIO card slot. The LTE communication card comprises: an SDIO interface, comprising data pins adapted to be selectively inserted into the SDIO card slot; an LTE baseband processing unit connected to the data pins, being configured to obtain the first data signal from the data pins and modulate the first data signal; an LTE transceiving unit connected to the LTE baseband processing unit, being configured to obtain the first data signal that has been modulated; and an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the SDIO card slot via the data pins. The data processing unit further obtains the second data signal from the SDIO card slot.

Preferably, the LTE communication card further comprises a memory connected to the LTE baseband processing unit and configured to store an SIN, an authentication key, an LAI, a TSI, a PIN, an unlock code, telephone book data, subscriber identification authentication data, an encryption algorithm and an encryption key.

Preferably, the electronic device further comprises a power module configured to supply power to the data processing unit and output a power signal to the SDIO card slot, the LTE communication card further comprises an LTE power management unit, the SDIO interface further comprises power pins adapted to be selectively inserted into the SDIO card slot of the electronic device, and the LTE power management unit is configured to obtain the power signal from the power pins and adjust the power signal correspondingly to power the LTE baseband processing unit, the LTE transceiving unit and the memory respectively.

Preferably, the SDIO interface, the LTE baseband processing unit, the LTE transceiving unit, the memory and the LTE power management unit are packaged in a card having dimensions of 32 mm×24 mm×2.1 mm.

As compared to the prior art, the present disclosure has the following benefits: the LTE communication card and the LTE communication system of the present disclosure have the SDIO interface, the LTE baseband processing unit, the LTE transceiving unit and the antenna unit integrated into the LTE communication card, and use the SDIO interface for data transmission. In this way, by inserting the LTE communication card into an electronic device that supports the SDIO protocol, the electronic device can be provided with the LTE wireless communication function. This enriches the functions of the electronic device, improves users' experiences and reduces the production cost.

### BRIEF DESCRIPTION OF THE DRAWINGS

FIG. 1 is a schematic circuit diagram of an LTE communication system according to a first embodiment of the present disclosure;

FIG. 2 is a schematic circuit diagram of an LTE communication system according to a second embodiment of the present disclosure;

FIG. 3 is a perspective front view of an LTE communication card of the present disclosure; and

FIG. 4 is a back view of the LTE communication card of the present disclosure.

### DETAILED DESCRIPTION OF THE INVENTION

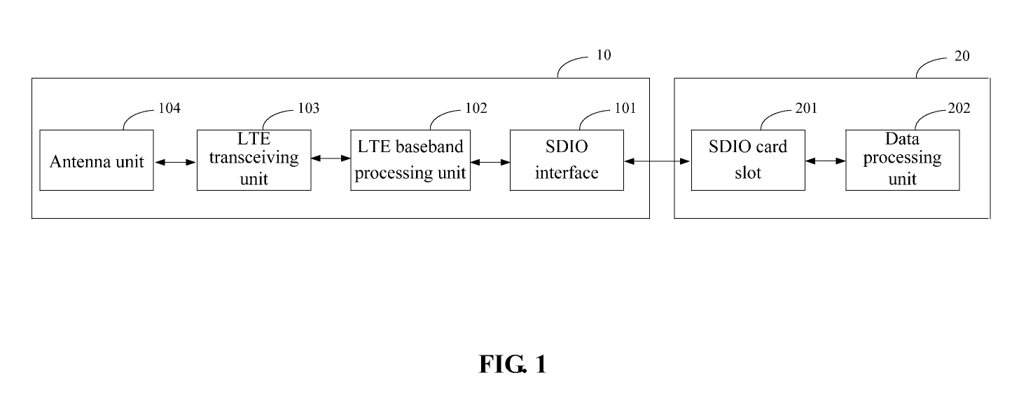

Referring firstly to FIG. 1, there is shown a schematic circuit diagram of an LTE communication system according to a first embodiment of the present disclosure. As shown in FIG. 1, the LTE communication system of the present disclosure comprises an LTE communication card 10 and an electronic device 20 in this embodiment.

The electronic device 20 comprises an SDIO card slot 201 and a data processing unit 202 connected to the SDIO card slot 201. The data processing unit 202 is configured to generate a first data signal to the SDIO card slot and receive a second data signal from the SDIO card slot.

The LTE communication card 10 comprises: an SDIO interface 101, comprising data pins adapted to be selectively inserted into the SDIO card slot 201 of the electronic device 20; an LTE baseband processing unit 102 connected to the data pins, being configured to obtain from the data pins the first data signal supplied by the electronic device 20 and modulate the first data signal; an LTE transceiving unit 103 connected to the LTE baseband processing unit 102, being configured to obtain the first data signal that has been modulated; and an antenna unit 104 connected to the LTE transceiving unit 103, being configured to transmit the first data signal, and further obtain an LTE radio frequency (RF) signal from the outside and transmit the LTE RF signal to the LTE transceiving unit 103. The LTE RF signal is transmitted by the LTE transceiving unit 103 to the LTE baseband processing unit 102 and then demodulated by the LTE baseband processing unit 102 to obtain the second data signal for transmission to the electronic device 20 via the data pins.

Here, the first data signal is an uplink data signal in the communication process, and the second data signal is a downlink data signal in the communication process. In this way, after the LTE communication card 10 is inserted into the SDIO card slot 201 of the electronic device 20, an LTE uplink/downlink data transceiving function will be obtained for the electronic device 20.

The LTE communication card 10 and the electronic device 20 of the present disclosure have the SDIO interface 101, the LTE baseband processing unit 102, the LTE transceiving unit 103 and the antenna unit 104 integrated into the LTE communication card 10, and use the SDIO interface for data transmission. In this way, the electronic device 20 that supports the SDIO protocol can transmit and receive the LTE uplink/downlink data through the LTE communication card 10. Thereby, after the LTE communication card 10 is inserted into the electronic device 20, the LTE wireless communication function can be easily obtained for the electronic device 20. This enriches the functions of the electronic device 20, improves users' experiences and reduces the production cost.

However, in the aforesaid embodiment, the technical solutions of the LTE communication card 10 and the electronic device 20 have been described only from the view point of data transmission, and no description is made on the way in which power is supplied. In the present disclosure, the LTE communication card 10 may be powered by a built-in battery or the electronic device 20, and is preferably powered by the electronic device 20. Therefore, how to use the electronic device 20 to power the LTE communication card 10 will be described in detail hereinblow in a second embodiment of the present disclosure.

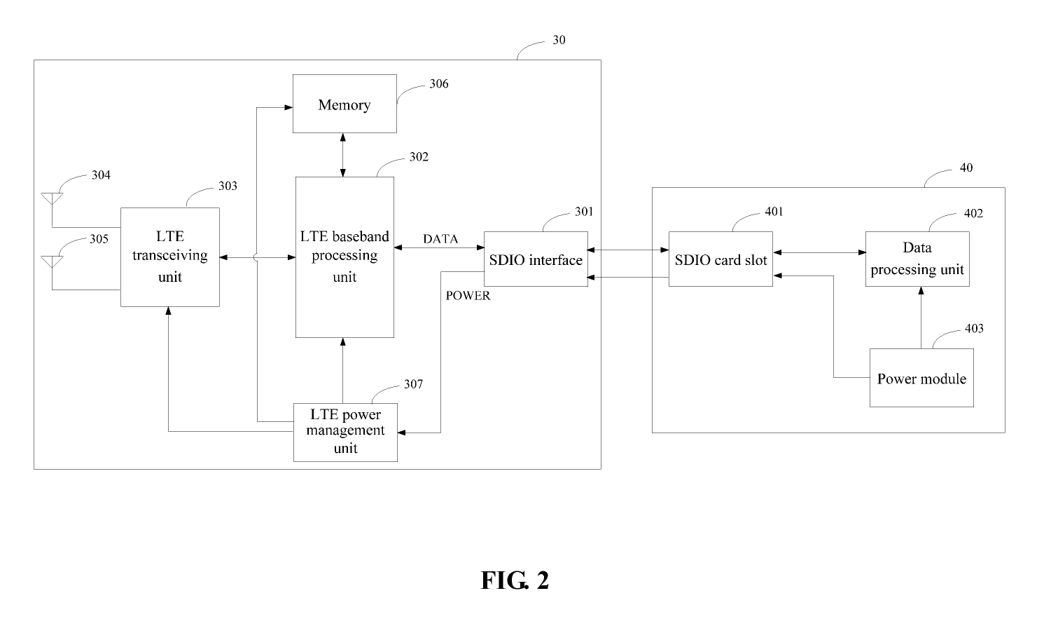

FIG. 2 is a schematic circuit diagram of an LTE communication system according to the second embodiment of the present disclosure. As shown in FIG. 2, the LTE communication system of the present disclosure comprises an electronic device 40 and an LTE communication card 30 in this embodiment.

The electronic device 40 comprises an SDIO card slot 401 and a data processing unit 402 connected to the SDIO card slot 401. The data processing unit 402 is configured to generate a first data signal to the SDIO card slot 401 and receive a second data signal from the SDIO card slot 401.

The LTE communication card 30 comprises: an SDIO interface 301, comprising data pins adapted to be selectively inserted into the SDIO card slot 401; an LTE baseband processing unit 302 connected to the data pins, being configured to obtain the first data signal from the data pins and modulate the first data signal; an LTE transceiving unit 303 connected to the LTE baseband processing unit 302, being configured to obtain the first data signal that has been modulated; and an antenna unit (comprising an LTE main antenna 304 and an LTE Multiple-Input Multiple-Output (MIMO) antenna 305) connected to the LTE transceiving unit 303, being configured to transmit the first data signal, and further obtain an LTE RF signal from the outside and transmit the LTE RF signal to the LTE transceiving unit 303. The LTE RF signal is transmitted by the LTE transceiving unit 303 to the LTE baseband processing unit 302 and then demodulated by the LTE baseband processing unit 302 to obtain the second data signal for transmission to the SDIO card slot 401 via the data pins. The data processing unit 402 further obtains the second data signal from the SDIO card slot 401.

In this embodiment, the LTE communication card 30 may further comprise a memory 306, which is connected to the LTE baseband processing unit 302 and configured to store a subscriber identification number (SIN), an authentication key, a location area identifier (LAI), a temporary subscriber identifier (TSI), a personal identification number (PIN), an unlock code, telephone book data, subscriber identification authentication data, an encryption algorithm and an encryption key. The SIN, the authentication key, the LAI, the TSI, the PIN, the unlock code, the telephone book data, the subscriber identification authentication data, the encryption algorithm and the encryption key are data originally stored in a Universal Subscriber Identity Module (USIM) card or a Subscriber Identity Module (SIM) card, and are now stored in the memory 306. The LTE baseband processing unit 302 may read these data and process these data correspondingly so that the LTE communication card 30 of the present disclosure can be provided with the functions corresponding to the USIM card or the SIM card. Therefore, a card slot for the USIM card or for the SIM card can be omitted from the electronic device 40 through use of the LTE communication card 30 of this embodiment, and this can significantly reduce the space of the electronic device 40 and make the electronic device 40 more lightweight and thinner.

Additionally, the LTE communication card 30 further comprises an LTE power management unit 307; the SDIO interface 301 further comprises power pins adapted to be selectively inserted into the SDIO card slot 401 of the electronic device 40; and the LTE power management unit 307 is configured to obtain from the power pins a power signal supplied by the electronic device 40 and adjust the power signal correspondingly to power the LTE baseband processing unit 302, the LTE transceiving unit 303 and the memory 306 respectively. Correspondingly, the electronic device 40 further comprises a power module 403, which is configured to supply power to the data processing unit 402 and output the power signal to the SDIO card slot 401 so that the LTE power management unit 307 can obtain from the power pins inserted into the SDIO card slot 401 the power signal supplied by the electronic device 40.

Thus, in the second embodiment of the present disclosure, the electronic device 40 is used to supply power to the LTE communication card 30 so that the LTE communication card 30 can also operate normally without a built-in power supply.

Specifically, in this embodiment, the SDIO interface 301, the LTE baseband processing unit 302, the LTE transceiving unit 303, the memory 306 and the LTE power management unit 307 are packaged in a card having dimensions of 32 mm×24 mm×2.1 mm, which is completely identical to a common SD card in shape.

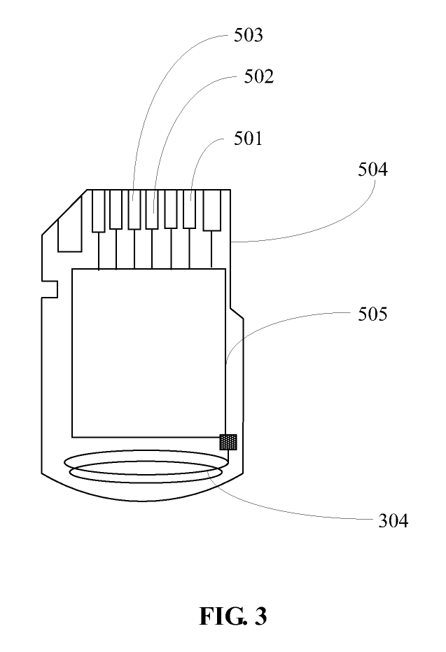

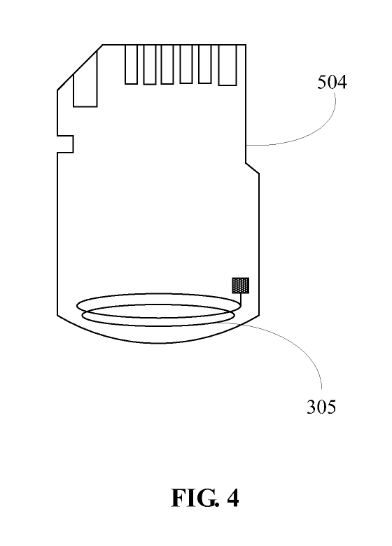

Moreover, the antenna unit comprises the LTE main antenna 304 and the LTE MIMO antenna 305 in this embodiment. The antenna unit is disposed in an edge region of an enclosure of the card that is opposite to the SDIO interface 301. This will be further detailed with reference to FIG. 3 and FIG. 4 hereinbelow. FIG. 3 is a front view of the LTE communication card 30 of the present disclosure, and FIG. 4 is a back view of the LTE communication card 30 of the present disclosure.

Referring further to FIG. 3, there is shown a perspective front view of the LTE communication card of the present disclosure. As shown in FIG. 3, a pin 501 and a pin 503 are ground pins and a pin 502 is a voltage supply pin, so the pin 501, the pin 502 and the pin 503 are just the power pins of the second embodiment while the other pins (not shown) are the data pins of the second embodiment. As shown in FIG. 3, the SDIO interface 301, the LTE baseband processing unit 302, the LTE transceiving unit 303, the memory 306 and the LTE power management unit 307 may be disposed on a circuit board 505. Specifically, as shown in FIG. 3 and FIG. 4, one of the LTE main antenna 304 and the LTE MIMO antenna 305 may be disposed in an edge region opposite to the SDIO interface 301 at a side of an enclosure 504 of the card, and the other of the LTE main antenna 304 and the LTE MIMO antenna 305 may be disposed in an edge region opposite to the SDIO interface 301 at the other side of the enclosure 504 of the card.

Hereinbelow, the specific layout of the LTE communication card will be introduced in detail with reference to FIG. 3 and FIG. 4. As shown in FIG. 3, the LTE main antenna 304 may be disposed in an edge region of the enclosure 504 opposite to the SDIO interface on a front side of the LTE communication card. Referring to FIG. 4, there is shown a back view of the LTE communication card of the present disclosure. The LTE MIMO antenna 305 may be disposed in an edge region of the enclosure 504 opposite to the SDIO interface on a back side of the LTE communication card.

The SDIO interface 301, the LTE baseband processing unit 302, the LTE transceiving unit 303, the memory 306 and the LTE power management unit 307 are packaged in a card having dimensions of 32 mm×24 mm×2.1 mm.

It is worth noting that, the LTE communication system described in the present disclosure includes but is not limited to a mobile phone, a personal computer (PC), a notebook computer, a tablet personal computer, a netbook, a personal digital assistant (PDA) and the like.

Accordingly, the present disclosure discloses an LTE communication card 30 and an LTE communication system, which have the SDIO interface 301, the LTE baseband processing unit 302, the LTE transceiving unit 303 and the antenna unit integrated into the LTE communication card 30, and use the SDIO interface 301 for data transmission. In this way, the electronic device 40 that supports the SDIO protocol can be easily provided with the LTE wireless communication function. This enriches the functions of the electronic device 40, improves users' experiences and reduces the production cost.

What described above are only some of the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A Long Term Evolution (LTE) communication card, comprising:
a Secure Digital Input and Output (SDIO) interface, comprising data pins adapted to be selectively inserted into an SDIO card slot of an electronic device;
an LTE baseband processing unit connected to the data pins, being configured to obtain from the data pins a first data signal supplied by the electronic device and modulate the first data signal;
an LTE transceiving unit connected to the LTE baseband processing unit, being configured to obtain the first data signal that has been modulated; and
an antenna unit connected to the LTE transceiving unit, being configured to transmit the first data signal, and further obtain an LTE radio frequency (RF) signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the electronic device via the data pins;
wherein the LTE communication card further comprises an LTE power management unit, the SDIO interface further comprises power pins adapted to be selectively inserted into the SDIO card slot of the electronic device, and the LTE power management unit is configured to obtain from the power pins a power signal supplied by the electronic device and adjust the power signal correspondingly to power the LTE baseband processing unit and the LTE transceiving unit respectively.

2. An LTE (Long Term Evolution) communication system, comprising:
an electronic device, comprising:
an SDIO card slot; and
a data processing unit connected to the SDIO card slot, being configured to generate a first data signal to the SDIO card slot; and
an LTE communication card, comprising:
an SDIO interface, comprising data pins adapted to be selectively inserted into the SDIO card slot;
an LTE baseband processing unit connected to the data pins, being configured to obtain the first data signal from the data pins and modulate the first data signal;
an LTE transceiving unit connected to the LTE baseband processing unit, being configured to obtain the first data signal that has been modulated; and
an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the SDIO card slot via the data pins;
wherein the data processing unit further obtains the second data signal from the SDIO card slot, and
the electronic device further comprises a power module configured to supply power to the data processing unit and output a power signal to the SDIO card slot, the LTE communication card further comprises an LTE power management unit, the SDIO interface further comprises power pins adapted to be selectively inserted into the SDIO card slot of the electronic device, and the LTE power management unit is configured to obtain the power signal from the power pins and adjust the power signal correspondingly to power the LTE baseband processing unit and the LTE transceiving unit respectively.

3. An LTE (Long Term Evolution) communication card, comprising:
an SDIO interface, comprising data pins adapted to be selectively inserted into an SDIO card slot of an electronic device;
an LTE baseband processing unit connected to the data pins, being configured to obtain from the data pins a first data signal supplied by the electronic device and modulate the first data signal;
an LTE transceiving unit connected to the LTE baseband processing unit, being configured to obtain the first data signal that has been modulated; and
an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the electronic device via the data pins.

4. The LTE communication card of claim 3, further comprising a memory connected to the LTE baseband processing unit and configured to store a subscriber identification number (SIN), an authentication key, a location area identifier (LAI), a temporary subscriber identifier (TSI), a personal identification number (PIN), an unlock code, telephone book data, subscriber identification authentication data, an encryption algorithm and an encryption key.

5. The LTE communication card of claim 4, further comprising an LTE power management unit, the SDIO interface further comprises power pins adapted to be selectively inserted into the SDIO card slot of the electronic device, and the LTE power management unit is configured to obtain from the power pins a power signal supplied by the electronic device and adjust the power signal correspondingly to power the LTE baseband processing unit, the LTE transceiving unit and the memory respectively.

6. The LTE communication card of claim 5, wherein the SDIO interface, the LTE baseband processing unit, the LTE transceiving unit, the memory and the LTE power management unit are packaged in a card having dimensions of 32 mm×24 mm×2.1 mm.

7. The LTE communication card of claim 6, wherein the antenna unit comprises an LTE main antenna and an LTE Multiple-Input Multiple-Output (MIMO) antenna.

8. The LTE communication card of claim 6, wherein the antenna unit is disposed in an edge region of an enclosure of the card that is opposite to the SDIO interface.

9. An LTE (Long Term Evolution) communication system, comprising:
an electronic device, comprising:
an SDIO card slot; and
a data processing unit connected to the SDIO card slot, being configured to generate a first data signal to the SDIO card slot; and
an LTE communication card, comprising:
an SDIO interface, comprising data pins adapted to be selectively inserted into the SDIO card slot;
an LTE baseband processing unit connected to the data pins, being configured to obtain the first data signal from the data pins and modulate the first data signal;
an LTE transceiving unit connected to the LTE baseband processing unit, being configured to obtain the first data signal that has been modulated; and
an antenna unit connected to the LTE transceiving unit, being configured to transmit the first data signal, and further obtain an LTE RF signal from the outside and transmit the LTE RF signal to the LTE transceiving unit, and the LTE RF signal being transmitted by the LTE transceiving unit to the LTE baseband processing unit and then demodulated by the LTE baseband processing unit to obtain a second data signal for transmission to the SDIO card slot via the data pins;
wherein the data processing unit further obtains the second data signal from the SDIO card slot.

10. The LTE communication system of claim 9, wherein the LTE communication card further comprises a memory connected to the LTE baseband processing unit and configured to store an SIN, an authentication key, an LAI, a TSI, a PIN, an unlock code, telephone book data, subscriber identification authentication data, an encryption algorithm and an encryption key.

11. The LTE communication system of claim 9, wherein the electronic device further comprises a power module configured to supply power to the data processing unit and output a power signal to the SDIO card slot, the LTE communication card further comprises an LTE power management unit, the SDIO interface further comprises power pins adapted to be selectively inserted into the SDIO card slot of the electronic device, and the LTE power management unit is configured to obtain the power signal from the power pins and adjust the power signal correspondingly to power the LTE baseband processing unit, the LTE transceiving unit and the memory respectively.

12. The LTE communication system of claim 9, wherein the SDIO interface, the LTE baseband processing unit, the LTE transceiving unit, the memory and the LTE power management unit are packaged in a card having dimensions of 32 mm×24 mm×2.1 mm.
